(19) United States
(12) Patent Application Publication
(10) Pub. No.: US 2024/0199982 A1
(43) Pub. Date: Jun. 20, 2024

(54) COMPOSITION

(71) Applicant: Conopco, Inc., d/b/a UNILEVER, Englewood Cliffs, NJ (US)

(72) Inventors: Alison CUMMINS, Ellesmere Port (GB); Siyu DONG, Shanghai (CN); Craig Warren JONES, Preton, Wirral (GB); Alastair Richard SANDERSON, Ellesmere Port (GB); Qin YIN, Shanghai (CN)

(73) Assignee: Conopco, Inc., d/b/a UNILEVER, Englewood Cliffs, NJ (US)

(21) Appl. No.: 18/286,818

(22) PCT Filed: Apr. 14, 2022
(86) PCT No.: PCT/EP2022/060047

§ 371 Date: Oct. 13, 2023

(30) Foreign Application Priority Data
Jun. 7, 2021 (EP) 21178090.3

(51) Int. Cl. C11D 1/72; C11D 1/29

(52) U.S. Cl. CPC C11D 1/72; C11D 1/29

(57) ABSTRACT

A surfactant comprising a C8-22 alkyl chain and a mole average of from 1 to 40 ethoxy late units, at least one alkoxy late unit or one alkyl chain comprising carbon obtained from carbon capture and a surfactant product comprising such a surfactant in a 50-95% aqueous suspension or solution.

The present invention relates to improved surfactants and surfactant products.

Despite the prior art there remains a need for improved surfactants and surfactant products.

Accordingly, and in a first aspect there is provided a surfactant comprising a C8-22 alkyl chain and a mole average of from 1 to 40 alkoxylate units, at least one alkoxylate unit or one alkyl chain comprising carbon obtained from carbon capture.

We have surprisingly found that such a surfactant has desirable fragrance performance characteristics when employed in cleaning compositions. We have also found that such composition have improved foaming characteristics in the pre-wash stage, during the wash and are also thicker before being added to water to form a liquor.

Improvement in fragrance performance/choice are highly desirable. Fragrances are often the most persuasive sensory component in a product and the behaviour of fragrances are strictly controlled such that too much does not leave the product such that none remains to be deposited on the fabrics during washing. Not enough leaving the product leads to a product with poor hedonics.

Improvement in visuals, in particular colour perception through film when the surfactant is employed in a water-soluble capsule is also a sensitive formulation constraint. The light absorbance spectrum of a product is a key factor in a product's colour stability. Not only can this lead to a variety in colour offerings between different products (where different products are affected differently by extraneous ultraviolet light, e.g. from the sun) but also the physical behaviour, in particular physical stability.

Ingredients which help decrease the absorption of light of the composition at around 335 to 400 nm in the product are highly desirable.

For surfactant containing products which are in liquid unit dose form, improvement in sequestrant precipitation is also a key concern as sequestrants are required for cleaning performance yet in low water conditions their performance is often strictly managed to avoid precipitation of sequestrant. Precipitation leads to clouding of the product and often crusting on the exterior of the water-soluble film used to encapsulate the product. Surfactants which improve the ability to formulate with powerful cleaning ingredients are highly desired.

Viscosity in a liquid formulation is also a key physical characteristic that can be affected by a change in raw material. A higher viscosity means improved product use confidence. Components that can deliver a higher viscosity without having to add expensive viscosity modifiers are highly desired.

Preferably, the alkoxylate is a propoxylate or an ethoxylate groups and it is possible for either or both to be present in any one surfactant material.

Preferably, the surfactant is a non-ionic surfactant or an anionic surfactant.

Where it is a non-ionic surfactant it preferably comprises from 5 to 9 EO groups. By from 5 to 9 EO groups means the mole average is from these end points.

Preferably the non-ionic surfactant is an alcohol ethoxylate and the alkyl chain comprises from 10 to 18 carbon atoms. Preferably, the alkyl chain is obtained from a non-fossil fuel source.

Alternatively, where the surfactant is an anionic surfactant, it is preferred that it is an alkyl ether sulphate surfactant. Preferably, such a surfactant has a mole average of from 1 to 5, more preferably from 1 to 3 ethoxylate groups.

### Carbon Capture

Carbon capture means the capture of a C₁ carbon, mostly, but not exclusively, as a gas and usually carbon dioxide or carbon monoxide (both herein referred to as COx). Carbon is preferably captured from waste emissions (e.g. exhaust gases from industrial processes, known as “point sources”) or from the atmosphere. The term carbon capture contrasts with the direct use of fossil fuels e.g. crude oil, natural gas, coal or peat as the source of carbon. However, carbon may be captured from the waste products arising from usage of fossil fuels, so for example carbon captured from the exhaust gases of the burning of fossil fuels in power generation. Capturing COₓ is most effective at point sources, such as large fossil fuel or biomass energy facilities, natural gas electric power generation plants, industries with major COₓ emissions, natural gas processing, synthetic fuel plants and fossil fuel-based hydrogen production plants. Extracting COₓ from air is also possible, although the far lower concentration of COₓ in air compared to combustion sources presents significant engineering challenges. Preferably, the carbon is captured from a point source.

Preferably, the method used to carbon is selected from biological separation, chemical separation, absorption, adsorption, gas separation membranes, diffusion, rectification or condensation or any combination thereof.

Processes that collect COₓ from the air may use solvents that either physically or chemically bind COₓ from the air. Solvents include strongly alkaline hydroxide solutions like, for example, sodium and potassium hydroxide. Hydroxide solutions in excess of 0.1 molarity can readily remove COₓ from air. Higher hydroxide concentrations are desirable and an efficient air contactor will use hydroxide solutions in excess of 1 molar. Sodium hydroxide is a particular convenient choice, but other solvents may also be of interest. Specifically, similar processes may be useful for organic amines as well. Examples of carbon capture include amine scrubbing in which COₓ-containing exhaust gas passes through liquid amines to absorb most of the COₓ. The carbon-rich gas is then pumped away. Preferably, the processes that collects COₓ from the air may use solvents selected from, sodium and potassium hydroxide or organic amines.

Carbon capture may include post combustion capture whereby the COₓ is removed from “flue” gases after combustion of a carbon fuel, e.g. fossil fuel or a bio-fuel. Carbon capture may also be pre-combustion, whereby the fossil fuel is partially oxidized, for instance in a gasifier. The CO from the resulting syngas (CO and H₂) reacts with added steam (H₂O) and is shifted into COₓ and H₂. The resulting CO₂ can be captured from the exhaust stream. Capture may be by oxy-fuel combustion carbon capture, whereby a power plant burns fossil fuel in oxygen. This results in a gas mixture comprising mostly steam and COₓ. The steam and carbon dioxide are separated by cooling and compressing the gas stream.

Preferably, the carbon is captured from flue gases after combustion of a carbon fossil fuel. Carbon dioxide may be removed from the atmosphere or ambient air, by supplying a CO₂ absorbing liquid. The CO₂ is then recovered from the liquid for use. Electrochemical methods for carbon dioxide recovery from alkaline solvents for carbon dioxide capture from air may be used as in US 2011/108421. Alternatively, the captured CO₂ may be captured as a solid or liquid for example as a bicarbonate, carbonate or hydroxide from which the CO₂ is extracted using well know chemistries.

### Transformation

The carbon may be temporarily stored before usage or used directly. Captured carbon undergoes a process of transformation to chemical products.

The capture carbon may be transformed biologically or chemically to e.g.
1. Short chain intermediates such as short chain alcohols.
2. Hydrocarbon intermediates such as hydrocarbon chains: alkanes, alkenes, etc.

These can be converted further to make the components of surfactants using well known chemistries e.g. chain growth reactions etc to: longer chain alkenes/olefins, alkanes, longer chain alcohols, aromatics and ethylene, ethylene oxide which is an excellent starter chemical for various ingredients in detergent compositions.

Preferably, the carbon captured is transformed into ethylene or ethylene oxide.

Various transformation pathways via such intermediates are possible. Preferably, the carbon captured is transformed by a process selected from chemical transformation by Fischer-Tropsch using a hydrogen catalyst; conversion to ethanol chemically using a catalyst of copper nanoparticles embedded in carbon spikes; solar photo-thermochemical alkane reverse combustion; or biological transformation, for example fermentation. One suitable example of transformation is a process in which a reactor converts carbon dioxide, water and electricity to methanol or ethanol and oxygen. An example of this process is provided by Opus 12 WO21252535, WO17192787, WO20132064, WO20146402, WO19144135 and WO20112919.
1. CO₂ or CO can be chemically transformed to liquid hydrocarbons by Fischer-Tropsch (FT) reactions with H₂ using metal catalysts. CO can be captured as CO or converted into carbon monoxide by a reverse water gas shift reaction. FT reactions are gas-based so solid C1 carbon sources may require gasification (the product of which is often terms “syngas”. The name comes from its use as intermediates in creating synthetic natural gas (SNG)).
2. CO₂ can be converted to ethanol chemically using a catalyst of copper nanoparticles embedded in carbon spikes.
3. Solar photo-thermochemical alkane reverse combustion reaction is a one-step conversion of CO₂ and water into oxygen and hydrocarbons using a photo-thermochemical flow reactor.
4. Biological transformation—biological organisms transform the carbon to usable chemicals. NB. This excludes natural process of bio-sequestration of CO₂ by plants via photosynthesis and then using the plant itself as a feedstock. Biological transformation as used here means harnessing organisms to produce a desired feedstock (such as a short chain alcohol).

Preferably biological transformation comprises fermentation of the C₁ carbon by micro-organisms such as C₁-fixing bacteria to useful chemicals. Fermentation is preferably gas fermentation (the C₁ feedstock is in gaseous form).

There are a variety of microorganisms that can be used in fermentation processes, including anaerobic bacteria such as Clostridium ljungdahlii strain PETC or ERI2, among others [See e.g., U.S. Pat. Nos. 5,173,429; 5,593,886 and 5,821,111; and references cited therein; see also WO98/00558. WO 00/68407 discloses strains of Clostridium ljungdahlii for the production of ethanol.

The ability of micro-organisms to grow on CO as a sole carbon source was first discovered in 1903. This was later determined to be a property of organisms that use the acetyl coenzyme A (acetyl CoA) biochemical pathway of autotrophic growth (also known as the Woods-Ljungdahl pathway and the carbon monoxide dehydrogenase/acetyl COA synthase (CODH/ACS) pathway). A large number of anaerobic organisms including carboxydotrophic, photosynthetic, methanogenic and acetogenic organisms have been shown to metabolize CO to various end products, namely CO₂, H₂, methane, n-butanol, acetate and ethanol. While using CO as the sole carbon source, all such organisms produce at least two of these end products.

Anaerobic bacteria, such as those from the genus Clostridium, have been demonstrated to produce ethanol from CO, CO₂ and H₂ via the acetyl CoA biochemical pathway. For example, various strains of Clostridium ljungdahlii that produce ethanol from gases are described in WO 00/68407, EP 117309, U.S. Pat. Nos. 5,173,429, 5,593,886, and 6,368,819, WO 98/00558 and WO 02/08438. The bacterium Clostridium autoethanogenum sp is also known to produce ethanol from gases (Abrini et al., Archives of Microbiology 161, pp 345-351 (1994)).

The process may further include a catalytic hydrogenation module. In embodiments utilizing a catalytic hydrogenation module, the acid gas depleted stream is passed to the catalytic hydrogenation module, prior to being passed to the deoxygenation module, wherein at least one constituent from the acid gas depleted stream is removed and/or converted prior to being passed to the deoxygenation module. At least one constituent removed and/or converted by the catalytic hydrogenation module is acetylene (C₂H₂).

The process may include at least one additional module selected from the group comprising: particulate removal module, chloride removal module, tar removal module, hydrogen cyanide removal module, additional acid gas removal module, temperature module, and pressure module.

Further examples of carbon capture technologies suitable to generate the ethanol stock for use in manufacturing ethoxy sub-units for use in the surfactants described herein are disclosed in WO 2007/117157, WO 2018/175481, WO 2019/157519 and WO 2018/231948.

### Manufacture of Alkyl

The C8-22 alkyl chain of the surfactant whether an alcohol ethoxylate or an alkyl ether sulphate is preferably obtained from a renewable source, e.g. carbon capture, and if not from a carbon capture source, or in addition to a carbon capture source then preferably from a triglyceride. A renewable source is one where the material is produced by natural ecological cycle of a living species, preferably by a plant, algae, fungi, yeast or bacteria, more preferably plants, algae or yeasts.

Preferred plant sources of oils are rapeseed, sunflower, maze, soy, cottonseed, olive oil and trees. The oil from trees is called tall oil. Most preferably Palm and Rapeseed oils are the source.

Algal oils are discussed in Energies 2019, 12, 1920 Algal Biofuels: Current Status and Key Challenges by Saad M. G. et al. A process for the production of triglycerides from biomass using yeasts is described in Energy Environ. Sci., 2019, 12, 2717 A sustainable, high-performance process for the economic production of waste-free microbial oils that can replace plant-based equivalents by Masri M. A. et al.

Non-edible plant oils may be used and are preferably selected from the fruit and seeds of Jatropha curcas, Calophyllum inophyllum, Sterculia feotida, Madhuca indica (mahua), Pongamia glabra (koroch seed), Linseed, Pongamia pinnata (karanja), Hevea brasiliensis (Rubber seed), Azadirachta indica (neem), Camelina sativa, Lesquerella fendleri, Nicotiana tabacum (tobacco), Deccan hemp, Ricinus communis L. (castor), Simmondsia chinensis (Jojoba), Eruca sativa. L., Cerbera odollam (Sea mango), Coriander (Coriandrum sativum L.), Croton megalocarpus, Pilu, Crambe, syringa, Scheleichera triguga (kusum), Stillingia, Shorea robusta (sal), Terminalia belerica roxb, Cuphea, Camellia, Champaca, Simarouba glauca, Garcinia indica, Rice bran, Hingan (balanites), Desert date, Cardoon, Asclepias syriaca (Milkweed), Guizotia abyssinica, Radish Ethiopian mustard, Syagrus, Tung, Idesia polycarpa var. vestita, Alagae, Argemone mexicana L. (Mexican prickly poppy, Putranjiva roxburghii (Lucky bean tree), Sapindus mukorossi (Soapnut), M. azedarach (syringe), Thevettia peruviana (yellow oleander), Copaiba, Milk bush, Laurel, Cumaru, Andiroba, Piqui, B. napus, Zanthoxylum bungeanum.

### Manufacture of Surfactant.

The ethanol manufactured through carbon capture processes is used to generate ethoxy subunits and, together with appropriate alkyl, chains is formed into the desired surfactant. Where sulphonation is required, for example to form an anionic surfactant such as alkyl ether sulphate, again, this is according to standard processes.

In a first step the ethanol (C₂H₅OH) is dehydrated to ethylene (C₂H₄) and this is a common industrial process.

Then the ethylene is oxidised to form ethylene oxide (C₂H₄O).

Finally, the ethylene oxide is then reacted with a long chain alcohol (e.g. C12/14 type fatty alcohol) via a polymerisation type reaction. This process is commonly referred to as ethoxylation and gives rise to surfactants that are known as alcohol ethoxylates and which are non-ionic surfactants.

By sulphonating these alcohol ethoxylates one forms the alkyl ether sulphate anionic surfactants.

### Alkoxylate Unit

The surfactant according to the present invention includes a mole average of from 1 to 40 alkoxylated units.

The alkoxylate unit in the surfactant may be selected from ethoxylate units, propoxylate (propylene oxide) units or the surfactant may comprise a combination of the ethoxylate units, propoxylate (propylene oxide) units.

If propoxylation is present, preferably the average degree of propoxylation is between 1 to 25, more preferably between 2 and 20, most preferably between 5 and 10.

In a preferred embodiment the surfactant is a reaction product of a higher linear alcohol and a mixture of ethylene and propylene oxides, containing a mixed chain of ethylene oxide and propylene oxide, terminated by a hydroxyl group.

When mixed alkoxylate groups are present, the alkoxy groups can be randomly ordered or present in blocks, preferably are present in blocks. For example, mixed ethoxy (EO)/propoxy (PO) groups might be ordered in EO/PO blocks, PO/EO blocks, EO/PO/EO blocks or PO/EO/PO blocks.

The alkoxylate unit in the surfactant may be present in the form of a block copolymer. Preferably the block copolymer has at least one block of a polyoxypropylene (PO) and having at least one other block of polyoxyethylene (EO) attached to the polyoxypropylene (PO) block. Additional blocks of polyoxyethylene or polyoxypropylene can be present in a molecule. These are nonionic surfactants.

Particularly useful polyoxypropylene-polyoxyethylene block copolymer are those comprising a centre block of polyoxypropylene units and blocks of polyoxyethylene units to each side of the centre block. Also suitable are those comprising a centre block of polyoxyethylene units and blocks of polyoxypropylene units to each side of the centre block.

### Manufacture of PO

The alkoxylate units in the surfactant may preferably comprises at least one propoxylate unit (PO) containing a carbon atom obtained from carbon capture. More preferably, at least 50% of the propoxylate groups and especially preferably at least 70% comprise carbon atoms obtained from carbon capture and most preferably all the propoxylate groups present in the surfactant contain a carbon atom obtained from carbon capture.

Preferably, less than 90%, preferably less than 10% of the propylene oxide groups comprise carbon atoms obtained from fossil fuel-based sources.

Preferably, more than 10%, preferably more than 90% of the propylene oxide groups comprise carbon atoms obtained from carbon capture-based sources.

### Manufacture of EO

The ethoxylate units in the surfactant comprises at least one ethoxylate containing a carbon atom obtained from carbon capture. More preferably, at least 50% of the ethoxylate groups and especially preferably at least 70% comprise carbon atoms obtained from carbon capture and most preferably all the ethoxylate groups present in the non-ionic surfactant contain a carbon atom obtained from carbon capture.

Preferably, the ethoxylate units in the surfactant comprises at least one ethoxylate containing two carbon atoms obtained from carbon capture. More preferably, at least 10% of the ethoxylate groups and especially preferably at least 70% comprise two carbon atoms obtained from carbon capture and most preferably all the ethoxylate groups present in the non-ionic surfactant contain two carbon atoms obtained from carbon capture.

Preferably, less than 90%, preferably less than 10% of the ethoxylate groups comprise carbon atoms obtained from fossil fuel-based sources.

Preferably, more than 10%, preferably more than 90% of the ethoxylate groups comprise carbon atoms obtained from carbon capture based sources.

The surfactant is preferably disposed in a detergent composition. More preferably a laundry liquid composition, a powder detergent composition, a liquid hand dishwash composition or such like. Where the composition is a laundry liquid it is preferably a liquid unit dose composition. Preferably, such a composition is contained in a water-soluble pouch. Preferably, the pouch as from one to four compartments. Preferably, the pouch is a unit dose of product and may be from 10 to 50 g in weight to represent a unit dose.

Where the surfactant is disposed in a laundry liquid composition it is preferred that the composition comprises from 50 to 95% wt. of the composition water. More preferably, the composition comprises from 70 to 90% water. On the other hand where the composition is a unit dose liquid laundry composition and one which is maintained in a water-soluble capsule, it is preferred that the water is from 0 to 15% wt. of the unit dose product.

However, the composition may also be a gel, powder as well as a liquid. Where the product is a liquid it may be a dilutable composition or an auto-dose composition. An auto-dose composition is one which is contained within a cartridge or such like and dispensed from within the washing machine when required.

Where the product is a dilutable it means that the consumer can purchase a concentrated product and take the concentrate home where it can be diluted to form a regular liquid laundry product. The dilution may require anything from 1 to 10 parts water to one part concentrate.

### Alcohol Ethoxylates

The surfactant preferably comprises a non-ionic surfactant. Preferably the surfactant comprises from 0.1 to 50% wt. non-ionic surfactant based on the total weight of surfactant. Such nonionic surfactants include, for example, polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of additional nonionic surfactant for use in the invention includes aliphatic C₁₂ to C₁₅ primary linear alcohol ethoxylates with an average of from 3 to 20, more preferably from 5 to 10 moles of ethylene oxide per mole of alcohol.

The alcohol ethoxylate may be provided in a single raw material component or by way of a mixture of components.

Anionic-Surfactants Anionic Surfactant are described in Anionic Surfactants Organic Chemistry (Surfactant Science Series Volume 56) edited By H. W. Stache (Marcel Dekker 1996).

Non-soap anionic surfactants are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed. Sodium and potassium are preferred.

The compositions comprising the surfactants of the invention may also include alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may also be used, such as non-ethoxylated primary and secondary alkyl sulphates with an alkyl chain length of from 10 to 18.

Mixtures of any of the above described materials may also be used.

Also commonly used in laundry liquid compositions and dishwash cleaning compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with a mole average of 3EO units per molecule.

The alkyl ether sulphate may be provided in a single raw material component or by way of a mixture of components.

### Percent Modem Carbon

The percentage modern carbon (pMC) level is based on measuring the level of radiocarbon (C14) which is generated in the upper atmosphere from where it diffuses, providing a general background level in the air. The level of C14, once captured (e.g. by biomass) decreases over time, in such a way that the amount of C14 is essentially depleted after 45,000 years. Hence the C14 level of fossil-based carbons, as used in the conventional petrochemical industry is virtually zero.

A pMC value of 100% biobased or biogenic carbon would indicate that 100% of the carbon came from plants or animal by-products (biomass) living in the natural environment (or as captured from the air) and a value of 0% would mean that all of the carbon was derived from petrochemicals, coal and other fossil sources. A value between 0-100% would indicate a mixture. The higher the value, the greater the proportion of naturally sourced components in the material, even though this may include carbon captured from the air.

The pMC level can be determined using the % Biobased Carbon Content ASTM D6866-20 Method B, using a National Institute of Standards and Technology (NIST) modem reference standard (SRM 4990C). Such measurements are known in the art are performed commercially, such as by Beta Analytic Inc. (USA). The technique to measure the C14 carbon level is known since decades and most known from carbon-dating archaeological organic findings.

In one embodiment, the ingredient comprising at least one ethoxylate unit and at least one carbon derived from carbon capture comprises carbons from point source carbon capture. These ingredients preferably have a pMC of 0 to 10%.

In an alternate embodiment, the ingredient comprising at least one ethoxylate unit and at least one carbon derived from carbon capture comprises carbons from direct air capture. These ingredients preferably have a pMC of 90 to 100%.

### Liquid Laundry Detergent Compositions

The following components may be mixed with the surfactants according to the invention when formulating liquid detergent compositions.

### Fatty Acid

Preferably, fatty acid is present at from 4 to 20% wt. of the composition (as measured with reference to the acid added to the composition), more preferably from 5 to 12% wt. and most preferably 6 to 8% wt.

Suitable fatty acids include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

For formula accounting purposes, in the formulation, fatty acids and/or their salts (as defined above) are not included in the level of surfactant or in the level of builder.

### Sequestrant

The detergent compositions may also preferably comprise a sequestrant material. Examples include the alkali metal citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

A preferred sequestrant is Dequest® 2066 (Diethylenetriamine penta(methylene phosphonic acid or Heptasodium DTPMP). HEDP (1-Hydroxyethylidene-1,1,-diphosphonic acid), is preferably not present.

In a preferred embodiment the composition comprises fatty acid and sequestrant.

### Preservative

Food preservatives are discussed In Food Chemistry (Belitz H.-D., Grosch W., Schieberle), 4th edition Springer.

The formulation contains a preservative or a mixture of preservatives, selected from benzoic acid and salts thereof, alkylesters of p-hydroxybenzoic acid and salts thereof, sorbic acid, diethyl pyrocarbonate, dimethyl pyrocarbonate, preferably benzoic acid and salts thereof, most preferably sodium benzoate. The preservative is present at 0.01 to 3 wt %, preferably 0.3 wt % to 1.5 w %. Weights are calculated for the protonated form.

### Cleaning Polymers

Anti-redeposition polymers stabilise the soil in the wash solution thus preventing redeposition of the soil. Suitable soil release polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above described materials may also be used.

A composition of the invention will preferably comprise from 0.025 to 8% wt. of one or more anti-redeposition polymers such as, for example, the alkoxylated polyethyleneimines which are described above.

### Soil Release Polymers

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The co-polyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; non-ionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

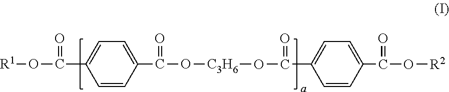

in which R¹ and R² independently of one another are X—(OC₂H₄)ₙ—(OC₃H₆)ₘ;
in which X is C¹⁴ alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent compositions herein in concentrations ranging from 0.01 percent to 10 percent, more preferably from 0.1 percent to 5 percent, by weight of the composition.

### Hydrotropes

A composition of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above described materials may also be used.

Non-aqueous carriers, are preferably included, may be present in an amount ranging from 1 to 50%, preferably from 10 to 30%, and more preferably from 15 to 25% (by weight based on the total weight of the composition). The level of hydrotrope used is linked to the level of surfactant and it is desirable to use hydrotrope level to manage the viscosity in such compositions. The preferred hydrotropes are monopropylene glycol and glycerol.

### Cosurfactants

A composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms preferably selected from C12, C14, C16, C18 and C18:1, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

### Fluorescent Agents

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt % the composition.

Preferred classes of fluorescer are: Di-styryl biphenyl compounds, e.g. Tinopal® CBS-X, Di-amine stilbene di-sulphonic acid compounds, e.g. Tinopal DMS pure Xtra, Tinopal 5BMGX, and Blankophor® HRH, and Pyrazoline compounds, e.g. Blankophor SN. Preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino} stilbene-2-2′ disulfonate, and disodium 4,4′-bis(2-sulfoslyryl)biphenyl.

Most preferably the fluoescer is a di-styryl biphenyl compound, preferably sodium 2,2′-([1,1′-biphenyl]-4,4′-diylbis(ethene-2,1-diyl)dibenzenesulfonate (CAS-No 27344-41-8).

### Shading Dyes

Shading dye can be used to improve the performance of the compositions. Preferred dyes are violet or blue. It is believed that the deposition on fabrics of a low level of a dye of these shades, masks yellowing of fabrics. A further advantage of shading dyes is that they can be used to mask any yellow tint in the composition itself.

Shading dyes are well known in the art of laundry liquid formulation.

Suitable and preferred classes of dyes include direct dyes, acid dyes, hydrophobic dyes, basic dyes, reactive dyes and dye conjugates. Preferred examples are Disperse Violet 28, Acid Violet 50, anthraquinone dyes covalently bound to ethoxylate or propoxylated polyethylene imine as described in WO2011/047987 and WO 2012/119859 alkoxylated mono-azo thiophenes, dye with CAS-No 72749-80-5, acid blue 59, and the phenazine dye selected from:

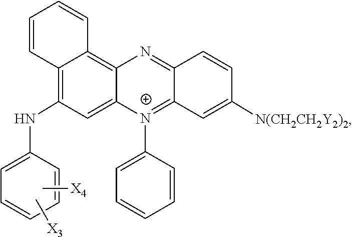

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH)CH₂OH; —OC(O)CH₃; and, C(O)OCH₃.

Alkoxylated thiophene dyes are discussed in WO2013/142495 and WO2008/087497.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class.

### External Structurants

Compositions of the invention may have their rheology further modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

### Enzymes

A composition of the invention may comprise an effective amount of one or more enzyme selected from the group comprising, pectate lyase, protease, amylase, cellulase, lipase, mannanase and mixtures thereof. The enzymes are preferably present with corresponding enzyme stabilizers.

### Fragrances

Fragrances are well known in the art and are preferably incorporated into compositions described herein at level of 1 to 5 wt %.

Preferably, the fragrance component is selected from the benzene, toluene, xylene (BTX) feedstock class. More preferably, the fragrance component is selected from 2-phenyl ethanol, phenoxanol and mixtures thereof.

Preferably, the fragrance component is selected from the cyclododecanone feedstock class. More preferably, the fragrance component is habolonolide.

Preferably, the fragrance component is selected from the phenolics feedstock class. More preferably, the fragrance component is hexyl salicylate.

Preferably, the fragrance component is selected from the C5 blocks or oxygen containing heterocycle moiety feedstock class. More preferably, the fragrance component is selected from gamma decalactone, methyl dihydrojasmonate and mixtures thereof.

Preferably, the fragrance component is selected from the terpenes feedstock class. More preferably, the fragrance component is selected from dihydromycernol, linalool, terpinolene, camphor, citronellol and mixtures thereof.

Preferably, the fragrance component is selected from the alkyl alcohols feedstock class.

More preferably, the fragrance component is ethyl-2-methylbutyrate.

Preferably, the fragrance component is selected from the diacids feedstock class. More preferably, the fragrance component is ethylene brassylate.

Preferably, the fragrance component listed above is present in the final detergent composition at from 0.0001 to 1% by wt. of the composition.

### Microcapsules

One type of microparticle suitable for use in the invention is a microcapsule.

Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material.

Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Alternatively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography. Polymeric core-shell microcapsules for use in the invention may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future microcapsule and the dimensions of the dispersed droplets directly determine the size of the subsequent microcapsules. Microcapsule shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell microcapsules. An example of a core-shell microcapsule produced by this method is a polyurea microcapsule with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed core material to produce a coherent film and the desired microcapsules. An example of a core-shell microcapsule produced by this method is an aminoplast microcapsule with a shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

One example of a preferred polymeric core-shell microcapsule for use in the invention is an aminoplast microcapsule with an aminoplast shell surrounding a core containing the fragrance formulation (f2). More preferably such an aminoplast shell is formed from the polycondensation product of melamine with formaldehyde.

Polymeric microparticles suitable for use in the invention will generally have an average particle size between 100 nanometers and 50 microns. Particles larger than this are entering the visible range. Examples of particles in the sub-micron range include latexes and mini-emulsions with a typical size range of 100 to 600 nanometers. The preferred particle size range is in the micron range. Examples of particles in the micron range include polymeric core-shell microcapsules (such as those further described above) with a typical size range of 1 to 50 microns, preferably 5 to 30 microns. The average particle size can be determined by light scattering using a Malvern Mastersizer with the average particle size being taken as the median particle size D (0.5) value. The particle size distribution can be narrow, broad or multimodal. If necessary, the microcapsules as initially produced may be filtered or screened to produce a product of greater size uniformity.

Polymeric microparticles suitable for use in the invention may be provided with a deposition aid at the outer surface of the microparticle. Deposition aids serve to modify the properties of the exterior of the microparticle, for example to make the microparticle more substantive to a desired substrate. Desired substrates include cellulosics (including cotton) and polyesters (including those employed in the manufacture of polyester fabrics).

The deposition aid may suitably be provided at the outer surface of the microparticle by means of covalent bonding, entanglement or strong adsorption. Examples include polymeric core-shell microcapsules (such as those further described above) in which a deposition aid is attached to the outside of the shell, preferably by means of covalent bonding. While it is preferred that the deposition aid is attached directly to the outside of the shell, it may also be attached via a linking species.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of β1-4 linked glucose residues), a mannan backbone (consisting of 31-4 linked mannose residues) or a xylan backbone (consisting of β1-4 linked xylose residues). Examples of such β1-4 linked polysaccharides include xyloglucans, glucomannans, mannans, galactomannans, β(1-3), (1-4) glucan and the xylan family incorporating glucurono-, arabino- and glucuronoarabinoxylans. Preferred β1-4 linked polysaccharides for use in the invention may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as loc ust bean gum (LBG) (which has a mannan backbone of β1-4 linked mannose residues, with single unit galactose side chains linked α1-6 to the backbone).

Also suitable are polysaccharides which may gain an affinity for cellulose upon hydrolysis, such as cellulose mono-acetate; or modified polysaccharides with an affinity for cellulose such as hydroxypropyl cellulose, hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

Deposition aids for use in the invention will generally have a weight average molecular weight (M_{w}) in the range of from about 5 kDa to about 500 kDa, preferably from about 10 kDa to about 500 kDa and more preferably from about 20 kDa to about 300 kDa.

One example of a particularly preferred polymeric core-shell microcapsule for use in the invention is an aminoplast microcapsule with a shell formed by the polycondensation of melamine with formaldehyde; surrounding a core containing the fragrance formulation (f2); in which a deposition aid is attached to the outside of the shell by means of covalent bonding. The preferred deposition aid is selected from β1-4 linked polysaccharides, and in particular the xyloglucans of plant origin, as are further described above.

The present inventors have surprisingly observed that it is possible to reduce the total level of fragrance included in the composition of the invention without sacrificing the overall fragrance experience delivered to the consumer at key stages in the laundry process. A reduction in the total level of fragrance is advantageous for cost and environmental reasons.

Accordingly, the total amount of fragrance formulation (f1) and fragrance formulation (f2) in the composition of the invention suitably ranges from 0.5 to 1.4%, preferably from 0.5 to 1.2%, more preferably from 0.5 to 1% and most preferably from 0.6 to 0.9% (by weight based on the total weight of the composition).

The weight ratio of fragrance formulation (f1) to fragrance formulation (f2) in the composition of the invention preferably ranges from 60:40 to 45:55. Particularly good results have been obtained at a weight ratio of fragrance formulation (f1) to fragrance formulation (f2) of around 50:50.

The fragrance (f1) and fragrance (f2) are typically incorporated at different stages of formation of the composition of the invention. Typically, the discrete polymeric microparticles (e.g. microcapsules) entrapping fragrance formulation (f2) are added in the form of a slurry to a warmed base formulation comprising other components of the composition (such as surfactants and solvents). Fragrance (f1) is typically post-dosed later after the base formulation has cooled.

### Further Optional Ingredients for Liquid Compositions

A composition comprising a surfactant of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

Many of the ingredients used in embodiments of the invention may be obtained from so called black carbon sources or a more sustainable green source. The following provides a list of alternative sources for several of these ingredients and how they can be made into raw materials described herein.

In a second aspect there is provided a surfactant product comprising a surfactant according to any preceding claim in a 50-95% aqueous suspension or solution.

### Particulate Laundry Detergent Compositions

Preferably, the laundry composition is a powder or particulate.

The term “particulate laundry detergent” in the context of this invention denotes free-flowing or compacted solid forms such as powders, granules, pellets, flakes, bars, briquettes or tablets and which are intended for and capable of wetting and cleaning domestic laundry such as clothing, linens and other household textiles. The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of laundry detergents include heavy-duty detergents for use in the wash cycle of automatic washing machines, as well as fine wash and colour care detergents such as those suitable for washing delicate garments (e.g. those made of silk or wool) either by hand or in the wash cycle of automatic washing machines.

One preferred form for the composition according to the invention is a free-flowing powdered solid, with a loose (unpackaged) bulk density generally ranging from about 200 g/l to about 1,300 g/l, preferably from about 400 g/l to about 1,000 g/l, more preferably from about 500 g/l to about 900 g/l.

The particulate composition of the invention comprises from 3 to 80%, preferably from 10 to 60%, and more preferably from 15 to 50% (by weight based on the total weight of the composition) of one or more detersive surfactants selected from non-soap anionic surfactants, nonionic surfactants and mixtures thereof.

The term “detersive surfactant” in the context of particulate detergent formulations denotes a surfactant which provides a detersive (i.e. cleaning) effect to laundry treated as part of a domestic laundering process.

In addition to the sulphated ethoxylated C₁₀ Guerbet alcohol surfactant as described above, other non-soap anionic surfactants for use in particulate compositions are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

Previously, a preferred class of non-soap anionic surfactant for use in particulate compositions includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Particulate compositions according to the invention may contain some alkyl benzene sulphonate in addition to the sulphated ethoxylated C₁₀ Guerbet alcohol surfactant as described above but it is preferred that the composition comprises less than 5% wt. more preferably less than 1% wt. and most preferably less than 0.1% wt. alkyl benzene sulphonate surfactant.

Mixtures of any of the above described materials may also be used.

In a typical particulate composition, the total level of non-soap anionic surfactant may suitably range from 5 to 25% (by weight based on the total weight of the composition).

Non-ionic surfactants may provide enhanced performance for removing very hydrophobic oily soil and for cleaning hydrophobic polyester and polyester/cotton blend fabrics. Nonionic surfactants for use in particulate compositions are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in particulate compositions includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

Mixtures of any of the above described materials may also be used.

In particulate compositions the total level of non-ionic surfactant may suitably range from 1 to 10% (by weight based on the total weight of the composition).

Examples of suitable mixtures of non-soap anionic and/or nonionic surfactants for use in particulate compositions include mixtures of linear alkylbenzene sulfonate (preferably C₁₁ to C₁₅ linear alkyl benzene sulfonate) if present with sulphated ethoxylated C₁₀ Guerbet alcohol surfactant as described above, with sodium lauryl ether sulfate (preferably C₁₀ to C₁₈ alkyl sulfate ethoxylated with an average of 1 to 3 EO) and/or ethoxylated aliphatic alcohol (preferably C₁₂ to C₁₅ primary linear alcohol ethoxylate with an average of from 5 to 10 moles of ethylene oxide per mole of alcohol).

A particulate composition may also contain one or more cosurfactants (such as amphoteric (zwitterionic) and/or cationic surfactants) in addition to the non-soap anionic and/or nonionic detersive surfactants described above.

Specific cationic surfactants include C₈ to C₁₈ alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the composition).

Specific amphoteric (zwitterionic) surfactants include alkyl amine oxides, alkyl betaines, alkyl amidopropyl betaines, alkyl sulphobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Preferably, a particulate composition may also include one or more builders. Builders are principally used to reduce water hardness. This is done either by sequestration or chelation (holding hardness minerals in solution), by precipitation (forming an insoluble substance), or by ion exchange (trading electrically charged particles). Builders can also supply and maintain alkalinity, which assists cleaning, especially of acid soils; help keep removed soil from redepositing during washing; and emulsify oily and greasy soils.

Builders for use in particulate compositions can be of the organic or inorganic type, or a mixture thereof. Non-phosphate builders are preferred.

Inorganic, non-phosphate builders for use in particulate compositions include carbonates, silicates, zeolites, and mixtures thereof.

Suitable carbonate builders for use in particulate compositions include mixed or separate, anhydrous or partially hydrated alkali metal carbonates, bicarbonates or sesquicarbonates. Preferably the alkali metal is sodium and/or potassium, with sodium carbonate being particularly preferred.

Suitable silicate builders include amorphous forms and/or crystalline forms of alkali metal (such as sodium) silicates. Preferred are crystalline layered sodium silicates (phyllosilicates) of the general formula (I)

NaMSiₓO₂ₓ₊₁·yH₂O (I)

in which M is sodium or hydrogen, x is a number from 1.9 to 4, preferably 2 or 3 and y is a number from 0 to 20. Sodium disilicates of the above formula in which M is sodium and x is 2 are particularly preferred. Such materials can be prepared with different crystal structures, referred to as α, β, γ and δ phases, with δ-sodium disilicate being most preferred.

Zeolites are naturally occurring or synthetic crystalline aluminosilicates composed of (SiO₄)⁴⁻ and (AlO₄)⁵⁻ tetrahedra, which share oxygen-bridging vertices and form cage-like structures in crystalline form. The ratio between oxygen, aluminium and silicon is O:(Al+Si)=2:1. The frameworks acquire their negative charge by substitution of some Si by Al. The negative charge is neutralised by cations and the frameworks are sufficiently open to contain, under normal conditions, mobile water molecules. Suitable zeolite builders for use in the invention may be defined by the general formula (II):

Naₓ[(AlO₂)ₓ(SiO₂)_{y}]·zH₂O (II)

in which x and y are integers of at least 6, the molar ratio of x to y is in the range from about 1 to about 0.5, and z is an integer of at least 5, preferably from about 7.5 to about 276, more preferably from about 10 to about 264.

Suitable organic, non-phosphate builders for use in particulate compositions include polycarboxylates, in acid and/or salt form. When utilized in salt form, alkali metal (e.g. sodium and potassium) or alkanolammonium salts are preferred. Specific examples of such materials include sodium and potassium citrates, sodium and potassium tartrates, the sodium and potassium salts of tartaric acid monosuccinate, the sodium and potassium salts of tartaric acid disuccinate, sodium and potassium ethylenediaminetetraacetates, sodium and potassium N(2-hydroxyethyl)-ethylenediamine triacetates, sodium and potassium nitrilotriacetates and sodium and potassium N-(2-hydroxyethyl)-nitrilodiacetates. Polymeric polycarboxylates may also be used, such as polymers of unsaturated monocarboxylic acids (e.g. acrylic, methacrylic, vinylacetic, and crotonic acids) and/or unsaturated dicarboxylic acids (e.g. maleic, fumaric, itaconic, mesaconic and citraconic acids and their anhydrides). Specific examples of such materials include polyacrylic acid, polymaleic acid, and copolymers of acrylic and maleic acid. The polymers may be in acid, salt or partially neutralised form and may suitably have a molecular weight (Mw) ranging from about 1,000 to 100,000, preferably from about 2,000 to about 85,000, and more preferably from about 2,500 to about 75,000.

Mixtures of any of the above described materials may also be used. Preferred builders for use in particulate compositions may be selected from zeolites (of the general formula (II) defined above), sodium carbonate, δ-sodium disilicate and mixtures thereof.

Preferably the level of phosphate builders in a particulate composition is less than 1% (by weight based on the total weight of the composition). The term “phosphate builder” denotes alkali metal, ammonium and alkanol ammonium salts of polyphosphate, orthophosphate, and/or metaphosphate (e.g. sodium tripolyphosphate).

Builder, when included, may be present in a total amount ranging from about 10 to about 80%, preferably from about 15 to 50% (by weight based on the total weight of the composition).

A particulate composition may also include one or more fillers to assist in providing the desired density and bulk to the composition. Suitable fillers for use in the invention may generally be selected from neutral salts with a solubility in water of at least 1 gram per 100 grams of water at 20° C.; such as alkali metal, alkaline earth metal, ammonium or substituted ammonium chlorides, fluorides, acetates and sulfates and mixtures thereof. Preferred fillers for use in the invention include alkali metal (more preferably sodium and/or potassium) sulfates and chlorides and mixtures thereof, with sodium sulfate and/or sodium chloride being most preferred.

Filler, when included, may be present in a total amount ranging from about 1 to about 80%, preferably from about 5 to about 50% (by weight based on the total weight of the composition).

A composition of the invention may contain one or more fatty acids and/or salts thereof.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

Fatty acids and/or their salts, when included, may be present in an amount ranging from about 0.25 to 5%, more preferably from 0.5 to 5%, most preferably from 0.75 to 4% (by weight based on the total weight of the composition).

For formula accounting purposes, in the formulation, fatty acids and/or their salts (as defined above) are not included in the level of surfactant or in the level of builder.

A particulate composition may also include one or more polymeric cleaning boosters. such as soil release polymers, anti-redeposition polymers, and mixtures thereof.

Soil release polymers adsorb onto a fabric surface assisting soil removal. Suitable soil release polymers for use in particulate compositions include co-polyesters of dicarboxylic acids (for example adipic acid, phthalic acid or terephthalic acid), diols (for example ethylene glycol or propylene glycol) and polydiols (for example polyethylene glycol or polypropylene glycol). An example of such a material has a midblock formed from propylene terephthalate repeat units and one or two end blocks of capped polyalkylene oxide, typically PEG 750 to 2000 with methyl end capping. The weight average molecular weight (M_{w}) of such materials generally ranges from about 1000 to about 20,000 and preferably ranges from about 1500 to about 10,000.

Mixtures of any of the above described materials may also be used.

When included, a composition of the invention will preferably comprise from 0.05 to 6%, more preferably from 0.1 to 5% (by weight based on the total weight of the composition) of one or more soil release polymer(s) such as, for example, the copolyesters which are described above.

Anti-redeposition polymers stabilise the soil in the wash solution thus preventing redeposition of the soil. Suitable anti-redeposition polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethylenimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 50, preferably from 15 to 40 alkoxy groups per modification. A preferred material is ethoxylated polyethyleneimine, with an average degree of ethoxylation being from 10 to 40, preferably from 15 to 35 ethoxy groups per ethoxylated nitrogen atom in the polyethyleneimine backbone. Another type of suitable anti-redeposition polymer for use in the invention includes cellulose esters and ethers, for example sodium carboxymethyl cellulose.

Mixtures of any of the above described materials may also be used.

When included, a particulate composition of the invention will preferably comprise from 0.05 to 6%, more preferably from 0.1 to 5% (by weight based on the total weight of the composition) of one or more anti-redeposition polymers such as, for example, the alkoxylated polyethyleneimines and/or cellulose esters and ethers which are described above.

A particulate composition of the invention may also include an oxidising agent to facilitate removal of tough food stains and other organic stains by chemical oxidation. The oxidising agent may, for example oxidize polyphenolic compounds commonly found in coffee, tea, wine, and fruit stains. Oxidation by the oxidising agent may also aid in bleaching, whitening, and disinfecting fabrics, and may also provide additional washing machine cleanliness and odour prevention. Suitable oxidising agents for use in the invention include peroxy bleach compounds such as sodium perborate monohydrate and tetrahydrate, and sodium percarbonate.

When included, a particulate composition will preferably comprise from 5 to 35%, preferably from 8 to 20% (by weight based on the total weight of the composition) of one or more oxidising agents such as the peroxy bleach compounds which are described above.

A bleaching activator such as N,N,N′,N′-tetraacetylethylenediamine (TAED) or sodium nonanoyloxybenzenesulfonate (NOBS) may be included in conjunction with the one or more oxidising agents to improve bleaching action at low wash temperatures.

A bleaching catalyst may also be included in addition to or instead of a bleach activator. Typical bleaching catalysts include complexes of heavy metal ions such as cobalt, copper, iron, manganese or combinations thereof; with organic ligands such as 1,4,7-triazacyclononane (TACN), 1,4,7-trimethyl-1,4,7-triazacyclononane (Me₃-TACN), 1,5,9-trimethyl-1,5,9-triazacyclononane, 1,5,9-triazacyclododecane, 1,4,7-triazacycloundecane, tris[2-(salicylideneamino)ethyl]amine or combinations thereof.

A particulate composition may also contain one or more chelating agents for transition metal ions. Such chelating agents may also have calcium and magnesium chelation capacity, but preferentially bind heavy metal ions such as iron, manganese and copper. Such chelating agents may help to improve the stability of the composition and protect for example against transition metal catalyzed decomposition of certain ingredients.

Suitable transition metal ion chelating agents include phosphonates, in acid and/or salt form. When utilized in salt form, alkali metal (e.g. sodium and potassium) or alkanolammonium salts are preferred. Specific examples of such materials include aminotris(methylene phosphonic acid) (ATMP), 1-hydroxyethylidene diphosphonic acid (HEDP) and diethylenetriamine penta(methylene phosphonic acid (DTPMP) and their respective sodium or potassium salts. HEDP is preferred. Mixtures of any of the above described materials may also be used.

Transition metal ion chelating agents, when included, may be present in an amount ranging from about 0.1 to about 10%, preferably from about 0.1 to about 3% (by weight based on the total weight of the composition). Mixtures of any of the above described materials may also be used.

A particulate composition may also comprise an effective amount of one or more enzyme selected from the group comprising, pectate lyase, protease, amylase, cellulase, lipase, mannanase and mixtures thereof. The enzymes are preferably present with corresponding enzyme stabilizers.

A particulate composition may contain further optional ingredients to enhance performance and/or consumer acceptability. Examples of such ingredients include dye transfer inhibitors (e.g. polyvinylpyrrolidone), foam control agents, preservatives (e.g. bactericides), anti-shrinking agents, anti-wrinkle agents, antioxidants, sunscreens, anti-corrosion agents, drape imparting agents, anti-static agents, ironing aids, colorants, fluorescers, pearlisers and/or opacifiers, and shading dye. Each of these ingredients will be present in an amount effective to accomplish its purpose. Generally, these optional ingredients are included individually at an amount of up to 5% (by weight based on the total weight of the composition).

### Packaging and Dosing

A composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of laundering fabric using a composition of the invention will usually involve diluting the dose of detergent composition with water to obtain a wash liquor and washing fabrics with the wash liquor so formed. In automatic washing machines the dose of detergent composition is typically put into a dispenser and from there it is flushed into the machine by the water flowing into the machine, thereby forming the wash liquor. From 5 up to about 65 litres of water may be used to form the wash liquor depending on the machine configuration. The dose of detergent composition may be adjusted accordingly to give appropriate wash liquor concentrations.

The dilution step preferably provides a wash liquor which comprises inter alia from about 3 to about 20 g/wash of detersive surfactants (as are further defined above). The wash liquor preferably has a pH of from above 7 to less than 13, preferably from above 7 to less than 10.5.

A subsequent aqueous rinse step and drying the laundry is preferred.

### Dishwash Compositions

Dish means a hard surface as is intended to be cleaned using a hand dish-wash composition and includes dishes, glasses, pots, pans, baking dishes and flatware made from any material or combination of hard surface materials commonly used in the making of articles used for eating and/or cooking.

### Surfactants for Dishwash Compositions

Surfactant (detergent active) is generally chosen from anionic and non-ionic detergent actives. The cleaning composition may further or alternatively comprise cationic, amphoteric and zwitterionic surfactants.

Suitable synthetic (non-soap) anionic surfactants are water-soluble salts of organic sulphuric acid mono-esters and sulphonic acids which have in the molecular structure a branched or straight chain alkyl group containing from 6 to 22 carbon atoms in the alkyl part.

Examples of such anionic surfactants are water soluble salts of alkyl benzene sulfonates, such as those in which the alkyl group contains from 6 to 20 carbon atoms; (primary) long chain (e.g. 6-22 C-atoms) alcohol sulphates (hereinafter referred to as PAS), especially those obtained by sulphating the fatty alcohols produced by reducing the glycerides of tallow or coconut oil; secondary alkanesulfonates; and mixtures thereof.

Also suitable are the salts of alkylglyceryl ether sulphates, especially of the ethers of fatty alcohols derived from tallow and coconut oil; fatty acid monoglyceride sulphates; sulphates of ethoxylated aliphatic alcohols containing 1-12 ethylenoxy groups; alkylphenol ethylenoxy-ether sulphates with from 1 to 8 ethylenoxy units per molecule and in which the alkyl groups contain from 4 to 14 carbon atoms; the reaction product of fatty acids esterified with isethionic acid and neutralised with alkali, and mixtures thereof. Previously, the preferred water-soluble synthetic anionic surfactants are the alkali metal (such as sodium and potassium) and alkaline earth metal (such as calcium and magnesium) salts of alkyl-benzenesulfonates and mixtures with olefinsulfonates and alkyl sulfates, and the fatty acid mono-glyceride sulfates.

Non-ionic surfactants tend to reduce the foam produced on use of the composition. Consumers frequently associate high foam with powerful cleaning so it may be desirable to avoid the use of non-ionic surfactant altogether. For compositions where this is not an issue a suitable class of non-ionic surfactants can be broadly described as compounds produced by the condensation of simple alkylene oxides, which are hydrophilic in nature, with an aliphatic or alkyl-aromatic hydrophobic compound having a reactive hydrogen atom. The length of the hydrophilic or polyoxyalkylene chain which is attached to any particular hydrophobic group can be readily adjusted to yield a compound having the desired balance between hydrophilic and hydrophobic elements. This enables the choice of non-ionic surfactants with the right HLB. Particular examples include: the condensation products of aliphatic alcohols having from 8 to 22 carbon atoms in either straight or branched chain configuration with ethylene oxide, such as a coconut alcohol/ethylene oxide condensates having from 2 to 15 moles of ethylene oxide per mole of coconut alcohol; condensates of alkylphenols having C6-C15 alkyl groups with 5 to 25 moles of ethylene oxide per mole of alkylphenol; and condensates of the reaction product of ethylene-diamine and propylene oxide with ethylene oxide, the condensates containing from 40 to 80 percent of ethyleneoxy groups by weight and having a molecular weight of from 5,000 to 11,000.

Other classes of non-ionic surfactants are: tertiary amine oxides of structure R1 R2R3N—O, where R1 is an alkyl group of 8 to 20 carbon atoms and R2 and R3 are each alkyl or hydroxyalkyl groups of 1 to 3 carbon atoms, e.g. dimethyldodecylamine oxide; tertiary phosphine oxides of structure R1R2R3P—O, where R1 is an alkyl group of 8 to 20 carbon atoms and R2 and R3 are each alkyl or hydroxyalkyl groups of 1 to 3 carbon atoms, for instance dimethyl-dodecylphosphine oxide; dialkyl sulphoxides of structure R1R2S═O, where R1 is an alkyl group of from 10 to 18 carbon atoms and R2 is methyl or ethyl, for instance methyl-tetradecyl sulphoxide; fatty acid alkylolamides, such as the ethanol amides; alkylene oxide condensates of fatty acid alkylolamides; and alkyl mercaptans. If non-ionic surfactant is to be employed the amount present in the cleaning compositions of the invention will generally be at least 0.1 wt. percent, preferably at least 0.5 wt. percent, more preferably at least 1.0 wt. percent, but not more than 20 wt. percent, preferably at most 10 wt. percent and more preferably not more than 5 wt. percent.

It is also possible optionally to include amphoteric, cationic or zwitterionic surfactants in the compositions.

Suitable amphoteric surfactants are derivatives of aliphatic secondary and tertiary amines containing an alkyl group of 8 to 20 carbon atoms and an aliphatic group substituted by an anionic water-solubilising group, for instance sodium 3-dodecylamino-propionate, sodium 3-dodecylaminopropane-sulfonate and sodium N 2-hydroxy-dodecyl-N-methyltaurate.

Examples of suitable cationic surfactants can be found among quaternary ammonium salts having one or two alkyl or aralkyl groups of from 8 to 20 carbon atoms and two or three small aliphatic (e.g. methyl) groups, for instance cetyltrimethylammonium chloride.

A specific group of surfactants are the tertiary amines obtained by condensation of ethylene and/or propylene oxide with long chain aliphatic amines. The compounds behave like non-ionic surfactants in alkaline medium and like cationic surfactants in acid medium.

Examples of suitable zwitterionic surfactants can be found among derivatives of aliphatic quaternary ammonium, sulfonium and phosphonium compounds having an aliphatic group of from 8 to 18 carbon atoms and an aliphatic group substituted by an anionic water-solubilising group, for instance betaine and betaine derivatives such as alkyl betaine, in particular C12-C16 alkyl betaine, 3-(N,N-dimethyl-N-hexadecylammonium)-propane 1-sulfonate betaine, 3-(dodecylmethyl-sulfonium)-propane 1-sulfonate betaine, 3-(cetylmethyl-phosphonium)-propane-1-sulfonate betaine and N,N-dimethyl-N-dodecyl-glycine. Other well known betaines are the alkylamidopropyl betaines e.g. those wherein the alkylamido group is derived from coconut oil fatty acids.

Further examples of suitable surfactants are compounds commonly used as surface-active agents given in the well-known textbooks: ‘Surface Active Agents’ Vol. 1, by Schwartz and Perry, Interscience 1949; ‘Surface Active Agents’ Vol. 2 by Schwartz, Perry and Berch, Interscience 1958; the current edition of ‘Mccutcheon's Emulsifiers and Detergents’ published by Manufacturing Confectioners Company; ‘Tenside-Taschenbuch’, H. Stache, 2nd Edn., Carl Hauser Verlag, 1981.

The total level of surfactant is preferably from 3 to 40% wt. of the composition and typically along with the sulphated Guerbet surfactant the ratio between the LAS and SLES is from 80:20 to 30:70. The preferred ratio between the SLES and the CAPB is from 4:1 to 7:1 and the ratio between the PAS and the SLES is from 1:1 to 2:1.

### Optional Ingredients for Dishwash Compositions

The composition may include optional ingredients, such as abrasive particles and additional ingredients which aid formulation properties, stability and cleaning performance.

Magnesium and/or sodium sulphate are desirably included from 0.5 to 5 wt. percent in order to ensure the desired rheological properties are achieved.

A preservative system is also desirable, for example a mixture of CIT and MIT. BIT may also be used. The level of preservative will vary according to the expected storage temperature and the quality of raw materials. From 0.0001 to 0.1 wt percent is typical.

Sodium EDTA chelant is advantageously included in the compositions at a level of 0.01 to 0.5 wt percent. DMDMH (glydant) may also be included into the compositions at level of from 0.005 to 1 wt percent.

When the composition contains one or more anionic surfactants, the composition may preferably comprise detergent builders in an amount of more preferably from 0.1 to 25 weight percent. Suitable inorganic and organic builders are well known to those skilled in the art. Citric acid is a preferred buffer/builder and may suitably be included at a level of from 0.01 to 0.5 wt percent.

The composition may also comprise ingredients such as colorants, whiteners, optical brighteners, soil suspending agents, detersive enzymes, compatible bleaching agents (particularly peroxide compounds and active chlorine releasing compounds), solvents, co-solvents, gel-control agents, freeze-thaw stabilisers, bactericides, preservatives, hydrotropes, polymers and perfumes.

Examples of optional enzymes include lipase, cellulase, protease, mannanase, and pectate lyase.

### Viscosity for Dishwash Compositions

The liquid composition according to the invention preferably has a viscosity from 100 to 10,000 mPa·s, more preferably from 200 to 8,000 mPa·s, even more preferably from 400 to 6,500 mPa·s, and still even more preferably from 800 to 5,000 mPa·s, as measured at a shear rate of 20 s⁻¹ and at a temperature of 25 degrees Celsius.

### Packaging for Dishwash Compositions

The liquid compositions may be packaged in any suitable form of container. Preferably the composition is packaged in a plastic bottle with a detachable closure/pouring spout. The bottle may be rigid or deformable. A deformable bottle allows the bottle to be squeezed to aid dispensing. If clear bottles are used they may be formed from PET. Polyethylene or clarified polypropylene may be used. Preferably the container is clear enough that the liquid, with any visual cues therein, is visible from the outside. The bottle may be provided with one or more labels, or with a shrink wrap sleeve which is desirably at least partially transparent, for example 50 percent of the area of the sleeve is transparent. The adhesive used for any transparent label should preferably not adversely affect the transparency.

### OTNE

Preferably, the detergent composition, whether laundry liquid, laundry powder or dishwash with the surfactant obtained from carbon capture comprises octahydrotetramethyl acetophenone (OTNE) which is a desirable synthetic fragrance component and which delivers a particularly attractive sandalwood and cedarwood fragrance effect to consumables.

OTNE is the abbreviation for the fragrance material with CAS numbers 68155-66-8, 54464-57-2 and 68155-67-9 and EC List number 915-730-3. Preferably the OTNE is present as a multi-constituent isomer mixture containing:
1-(1,2,3,4,5,6,7,8-octahydro-2,3,8,8-tetramethyl-2-naphthyl)ethan-1-one (CAS 54464-57-2)
1-(1,2,3,5,6,7,8,8a-octahydro-2,3,8,8-tetramethyl-2-naphthyl)ethan-1-one (CAS 68155-66-8)
1-(1,2,3,4,6,7,8,8a-octahydro-2,3,8,8-tetramethyl-2-naphthyl)ethan-1-one (CAS 68155-67-9)

More particularly, the invention has to do with amber-like fragrance compositions for use in perfumery composed of octahydro-2′,3′,8′,8′-tetramethyl-(2′ or 3′)-acetonaphthones in which a majority of said acetonaphthones contains the double bond in the 9′-10′ position.

Such OTNE and its method for manufacture is described fully in U.S. Pat. No. 3,907,321 (IFF).

The fragrance Molecule 01 is a specific isomer of OTNE, commercially available from IFF. Another commercially available fragrance Escentric 01 contains OTNE but also ambroxan, pink pepper, green lime with balsamic notes like benzoin mastic and incense. Typically, commercially available fragrance raw materials comprise from 1 to 8% wt. of the fragrance raw material OTNE.

Preferably, the detergent composition comprises 0.01 to 0.2% wt. of the composition OTNE as described above. More preferably, from 0.07 to 0.15% wt. of the composition OTNE.

Regarding additional or alternative fragrance components the following are preferred.

Preferably, the fragrance component is selected from the benzene, toluene, xylene (BTX) feedstock class. More preferably, the fragrance component is selected from 2-phenyl ethanol, phenoxanol and mixtures thereof.

Preferably, the fragrance component is selected from the cyclododecanone feedstock class. More preferably, the fragrance component is habolonolide.

Preferably, the fragrance component is selected from the phenolics feedstock class. More preferably, the fragrance component is hexyl salicylate.

Preferably, the fragrance component is selected from the C5 blocks or oxygen containing heterocycle moiety feedstock class. More preferably, the fragrance component is selected from gamma decalactone, methyl dihydrojasmonate and mixtures thereof.

Preferably, the fragrance component is selected from the terpenes feedstock class. More preferably, the fragrance component is selected from dihydromycernol, linalool, terpinolene, camphor, citronellol and mixtures thereof.

Preferably, the fragrance component is selected from the alkyl alcohols feedstock class. More preferably, the fragrance component is ethyl-2-methylbutyrate.

Preferably, the fragrance component is selected from the diacids feedstock class. More preferably, the fragrance component is ethylene brassylate.

Preferably, the fragrance component listed above is present in the final detergent composition at from 0.0001 to 1% by wt. of the composition.

### EXAMPLES

The following non-ionic surfactants are illustrated and are all alcohol ethoxylates as described herein. Non-ionic surfactants 1 and 5 are comparative while 2, 3, 4, 6, 7 and 8 are inventive.

| | Ethoxylate (7EO) | Alkyl (C12) |
|---|---|---|
| Non-ionic Surfactant 1 | Petro | Petro |
| Non-ionic Surfactant 2 | Petro | Carbon Capture |
| Non-ionic Surfactant 3 | Carbon Capture | Petro |
| Non-ionic Surfactant 4 | Carbon Capture | Carbon Capture |
| | Ethoxylate (7EO) | Alkyl (C18) |
| Non-ionic Surfactant 5 | Petro | Petro |
| Non-ionic Surfactant 6 | Petro | Carbon Capture |
| Non-ionic Surfactant 7 | Carbon Capture | Petro |
| Non-ionic Surfactant 8 | Carbon Capture | Carbon Capture |

The following anionic surfactants are alkyl ether sulphates as described herein. Anionic surfactants 1, 5, 9 and 13 are comparative while the remaining are inventive.

| | Ethoxylate (3EO) | Alkyl (C12) |
|---|---|---|
| Anionic Surfactant 1 | Petro | Petro |
| Anionic Surfactant 2 | Petro | Carbon Capture |
| Anionic Surfactant 3 | Carbon Capture | Petro |
| Anionic Surfactant 4 | Carbon Capture | Carbon Capture |
| | Ethoxylate (3EO) | Alkyl (C18) |
| Anionic Surfactant 5 | Petro | Petro |
| Anionic Surfactant 6 | Petro | Carbon Capture |
| Anionic Surfactant 7 | Carbon Capture | Petro |
| Anionic Surfactant 8 | Carbon Capture | Carbon Capture |
| | Ethoxylate (1EO) | Alkyl (C12) |
| Anionic Surfactant 9 | Petro | Petro |
| Anionic Surfactant 10 | Petro | Carbon Capture |
| Anionic Surfactant 11 | Carbon Capture | Petro |
| Anionic Surfactant 12 | Carbon Capture | Carbon Capture |
| | Ethoxylate (1EO) | Alkyl (C18) |
| Anionic Surfactant 13 | Petro | Petro |
| Anionic Surfactant 14 | Petro | Carbon Capture |
| Anionic Surfactant 15 | Carbon Capture | Petro |
| Anionic Surfactant 16 | Carbon Capture | Carbon Capture |

All the surfactants here are suitable for storage as a solution or suspension 50-95% in water.

It should be appreciated that the ratio of Carbon Capture to Petro derived carbon can vary within batches. In any case, in the context of these examples, ‘Carbon capture’ means that at least 10% of the carbon atoms in the appropriate part of the molecule are obtained from carbon capture means. By ‘Petro’ is meant that at least 90% of the carbons are obtained from petrochemical means.

By Ethoxylate (XEO) is meant that the surfactant has a mole average number X ethoxylate groups.

By Alkyl (CX) is means that the surfactant has a mole average of X atoms in the alkyl chain.

This is a laundry liquid formulation which may comprise any of the carbon capture sourced surfactants described below.

| Ingredient | Weight % |
|---|---|
| Linear alkyl benzene sulfonate acid | 8.2 |
| Alcohol ethoxylate | 6.2 |
| Sodium lauryl ether sulfate with 3 moles of EO | 6.2 |
| Monoethanolamine | 3.5 |
| Citric acid | 2 |
| Sodium benzoate | 1.0 |
| Potassium sulfite | 0.2 |
| Ethoxylate polyethylene imine | 1.2 |
| Polyester soil release polymer | 0.4 |
| Dequest 2010 | 0.5 |
| perfume | 1.3 |
| fluorescer | 0.2 |
| remainder | water |

This is a laundry liquid unit dose formulation and which may be used to comprise any of the surfactants obtained through carbon capture.

| | |
|---|---|
| Ingredient | Weight % |

| | | |
|---|---|---|
| Alcohol ethoxylate | 20.0 | 26.9 |
| Glycerol | 14.2 | 16.3 |
| Fatty Acid | 13.9 | 6.9 |
| LAS | 13.8 | 13.8 |
| Mono propylene glycol | 11.6 | 11.6 |
| Monoethanolamine | 6.9 | 4.9 |
| enzymes | 5.2 | 5.2 |
| perfume | 4.4 | 4.4 |
| Polyester cleaning polymer | 4.3 | 4.3 |
| Dequest 2066 | 2.8 | 2.8 |
| cleaning polymer | 2.0 | 2.0 |
| potassium sulphite | 0.4 | 0.4 |
| TinoPal CBS-CL | 0.3 | 0.3 |
| water | 0.2 | 0.2 |

### Example 2

This shows the different levels of volatiles in the headspace for un-fragranced detergent compositions.

The values are the summed highest 50 peaks taken from a GC trace.

| | L | M |
|---|---|---|
| Test 1 | 424 000 000 | 370 000 000 |
| Test 2 | 408 000 000 | 372 000 000 |

The table shows that the volatiles in the carbon capture based containing surfactant are notably higher than in the petro-derived equivalent. The test surfactant is a non-ionic alcohol ethoxylate 7EO comprising carbon capture based ethoxylate groups.

The fragrance assessment is that the carbon capture derived surfactant results in a sweeter, more fruity profile than the petro version.

### Example 3

We have also found that compositions comprising such surfactants have improved foaming characteristics in the pre-wash stage, during the wash and are also thicker before being added to water to form a liquor.

1. A surfactant comprising a C8-22 alkyl chain and a mole average of from 1 to 40 ethoxylate units, at least one alkoxylate unit or one alkyl chain comprising carbon obtained from carbon capture.

2. A surfactant according to claim 1 which is an alcohol ethoxylate, alkyl ether carboxylate or an alkyl ether sulphate.

3. A surfactant according to claim 1 wherein both carbon atoms in at least one alkoxylate, preferably ethoxylate units or one of the alkyl chains is obtained from carbon capture.

4. A surfactant according to claim 1 wherein at least 10% of the alkoxylate, preferably ethoxylate groups or at least 10% of the alkyl chains comprise carbon atoms obtained from carbon capture and most preferably all the alkoxylate, preferably ethoxylate groups or all of the alkyl chains contain a carbon atom obtained from carbon capture.

5. A surfactant according to claim 1 wherein substantially all the alkoxylate, preferably ethoxylate groups or all of the alkyl chains present in the surfactant contain a carbon atom obtained from carbon capture.

6. A surfactant according to claim 1 wherein at least 10% of the alkoxylate, preferably ethoxylate groups comprise two carbon atoms obtained from carbon capture.

7. A surfactant according to claim 1 wherein substantially all the alkoxylate, preferably ethoxylate groups contain carbon atoms obtained from carbon capture.

8. A surfactant according to claim 1 wherein the carbon obtained from carbon capture is obtainable from gaseous carbon dioxide.

9. A surfactant according to claim 1 wherein the carbon obtained from carbon capture is obtainable from physically or chemically binding carbon dioxide from flue gas.

10. A surfactant according to claim 1 wherein the carbon obtained from carbon capture is obtainable from physically or chemically binding carbon dioxide from air.

11. A surfactant according to claim 1 wherein the carbon obtained from carbon capture comprises carbon obtainable by transforming carbon dioxide to form ethanol by a process selected from chemical transformation by Fischer-Tropsch using a hydrogen catalyst; conversion to ethanol chemically using a catalyst of copper nanoparticles embedded in carbon spikes; solar photo-thermochemical alkane reverse combustion; or biological transformation.

12. A surfactant according to claim 1 wherein less than 90%, preferably less than 10% of the alkoxylate, preferably ethoxylate groups comprise carbon atoms obtained from petroleum-based sources.

13. A surfactant according to claim 1 wherein the C8-22 alkyl is obtained from a renewable source, more preferably from a plant, algae or yeast.

14. A surfactant product comprising a surfactant according to claim 1 in a 50-95% aqueous suspension or solution.

15. A detergent comprising from 1 to 50% wt. of the detergent a surfactant according to claim 1 selected from laundry liquid compositions, powder detergent compositions, liquid hand dish wash compositions and hard surface cleaning compositions.
